(19) United States
(12) Patent Application Publication
(10) Pub. No.: US 2026/0309855 A1
(43) Pub. Date: Oct. 8, 2026

(54) Device-Centric Bistatic and Multistatic Radar

(71) Applicant: Telefonaktiebolaget LM Ericsson (publ), Stockholm (SE)

(72) Inventors: Henrik Sjöland, Lund (SE); Rickard Ljung, Helsingborg (SE); Andres Reial, Höllviken (SE); Magnus Sandgren, Staffanstorp (SE)

(21) Appl. No.: 19/481,693

(22) PCT Filed: May 11, 2023
(86) PCT No.: PCT/EP2023/062640

§ 371 Date: Nov. 5, 2025

(51) Int. Cl. G01S 13/00; G01S 7/00; H04W 4/38

(52) U.S. Cl. CPC G01S 13/003; G01S 7/006; H04W 4/38

(57) ABSTRACT

A multi-device radar sensing is performed in an arrangement comprising a sensing device (101, 201, 701) and one or more other devices including an illuminating device (103, 203, 703). The sensing device (101, 201, 701) transmits (711, 801) a radar illumination assistance request (211, 713) and receives (723, 725, 803) a response to the radar illumination assistance request (211, 713) from a set (303) of one or more responding devices (203, 207, 209). A relative position of each member of a set (401) of candidate devices (203, 209, 703, 707) is determined (729, 805), wherein the set (401) of candidate devices (203, 209, 703, 707) consists of one or more members of the set (303) of one or more responding devices (203, 207, 209). One of the responding devices is selected (807) from the set (401) of candidate devices (203, 209, 703, 707) for use as an illuminating device (103, 203, 703), wherein the selecting is based at least in part on the determined relative positions. The illuminating device (103, 203, 703) is configured (809) to perform radar illumination. The sensing device (101, 201, 701) senses (811) reflections (123, 749) of illumination signals (745) transmitted by the illuminating device (103, 203, 703).

### BACKGROUND

The present invention relates to performance of bistatic and/or multistatic radar operations by plural wireless devices, and more particularly to technology that enables a wireless device to configure one or more other wireless devices to engage in bistatic and/or multistatic radar operations.

Some or all of the following abbreviations are used in this specification:

| Abbreviation | Explanation |
|---|---|
| ADC | Analog-to-Digital Converter |
| AoA | Angle of Arrival |
| AR | Augmented Reality |
| SNR | Signal to Noise Ratio |
| VR | Virtual Reality |

Present literature describes several approaches for providing bistatic and multistatic radar functionality between wireless devices. As part of setting up such functionality among devices, there is often a need to select which device, from among several, will participate in the radar functionality. Solutions for device selection based on the device suitability exist. For example, WO 2022/191941 A1 (“Communication system radar signaling”), describes a method of reporting radar signal measuring capability for purposes of potentially participating in a radar function. The capability can in such solutions be static or dynamic. Dynamic factors include the band/band combination used (for radar and/or for other signaling), the Rx chain/Rx panel/antenna element(s) used, and/or the existence of physical obstructions of an antenna. Examples of static factors are the ADC bit length and receiver sensitivity.

In order to perform monostatic radar measurements, a device must support full duplex operation (i.e., able to receive and transmit simultaneously at the same frequency channel). Most wireless devices do not have such capability, and providing such would require significant modification of the radio front end.

This makes bistatic or multistatic radar measurement a better fit for such devices (i.e., because a device needs only to receive or transmit at any given time), but such operation requires support from a system of other units, with well-known positions, good synchronization and favorable channel conditions. Drawbacks to this approach include:
such a system may not be present or available at the present location;
the channel conditions may not be sufficiently good;
the device's own position, as well as the positions of other devices, may not be known with sufficient accuracy.

Approaches for dynamically setting up cooperation between nodes or devices for wireless sensing have been discussed in the context of IEEE 802.11 operation. However, the cooperating unit selection criteria and the required side information (e.g., device mobility, transmit/receive bandwidth capability, frequency spectrum, etc.) about the units differs significantly between the sensing (i.e., mere detection of presence) and radar measurement (i.e., quantification of an aspect of an object's location, such as relative distance) use cases.

There is thus a need for a technology that solves the problem of selecting cooperating units for bi- or multistatic radar measurement support and for obtaining relative position information between the cooperating units.

### SUMMARY

It should be emphasized that the terms “comprises” and “comprising”, when used in this specification, are taken to specify the presence of stated features, integers, steps or components; but the use of these terms does not preclude the presence or addition of one or more other features, integers, steps, components or groups thereof.

Moreover, reference letters may be provided in some instances (e.g., in the claims and summary) to facilitate identification of various steps and/or elements. However, the use of reference letters is not intended to impute or suggest that the so-referenced steps and/or elements are to be performed or operated in any particular order.

In accordance with one aspect of the present invention, the foregoing and other objects are achieved in technology (e.g., methods, apparatuses, nontransitory computer readable storage media, program means) for performing a multi-device radar sensing.

Some aspects of the inventive technology involve actions performed by a sensing device and comprise transmitting a radar illumination assistance request from the sensing device A response to the radar illumination assistance request is received from a set of one or more responding devices. A relative position of each member of a set of candidate devices is determined, wherein the set of candidate devices consists of one or more members of the set of one or more responding devices.

One of the responding devices is/are selected from the set of candidate devices for use as an illuminating device, wherein the selecting is based at least in part on the determined relative positions. The illuminating device is configured to perform radar illumination. Reflections of illumination signals transmitted by the illuminating device are then sensed by the sensing device.

In some but not necessarily all alternative embodiments, more than one of the responding devices are selected for use as illuminating devices. These are then configured to perform radar illumination.

In another aspect of some but not necessarily all embodiments, direct path illumination signals are sensed from the illuminating device. A relative location of an object with respect to the sensing device is determined based on the sensed reflections, the sensed direct path illumination signals, and the relative position of the illuminating device.

In yet another aspect of some but not necessarily all embodiments, each of the responses to the radar illumination assistance request indicates a radar transmission ability of a corresponding member of the set of one or more responding devices.

In still another aspect of some but not necessarily all embodiments, determining the relative position of each member of the set of candidate devices comprises receiving, from each member of the set of candidate devices, at least one ranging transmission that is configured for use as a basis for estimating a range between the sensing device and the member of the set of candidate devices.

In another aspect of some but not necessarily all such embodiments, determining the relative position of each member of the set of candidate devices comprises, for each member of the set of candidate devices, determining an angle of arrival of the at least one ranging transmission received from the member of the set of candidate devices.

In yet another aspect of some but not necessarily all such embodiments, determining the relative position of each member of the set of candidate devices comprises, for each member of the set of candidate devices, estimating a distance between the sensing device and the member of the set of candidate devices.

In still another aspect of some but not necessarily all embodiments, estimating the distance between the sensing device and the member of the set of candidate devices comprises determining a round trip time that comprises a combination of:
a travel time of a first signal from the sensing device to the member of the set of candidate devices;
a known delay time between receipt of the signal by the member of the set of candidate devices and transmission of a second signal by the member of the set of candidate devices; and
a travel time of the second signal from the member of the set of candidate devices to the sensing device.

In another aspect of some but not necessarily all embodiments, determining the angle of arrival of the at least one ranging transmission received from the member of the set of candidate devices comprises using an antenna array of the sensing device to perform null-scanning over a geographical region.

In yet another aspect of some but not necessarily all embodiments, each response to the radar illumination assistance request received from a member of the set of candidate devices is the ranging transmission received from the member of the set of candidate devices. In some but not necessarily all alternatives, a ranging signal request is transmitted to a member of the set of candidate devices, and the ranging transmission is received from the member of the set of candidate devices in response to the ranging signal request.

In still another aspect of some but not necessarily all embodiments, the ranging transmission indicates a mobility attribute of the member of the set of candidate devices.

In another aspect of some but not necessarily all embodiments, the selecting of the illuminating device from the set of candidate devices is based at least in part on one or more of:
a detection geometry associated with each member of the set of candidate devices;
a distance between the sensing device and each member of the set of candidate devices;
one or more mobility attributes of each member of the set of candidate devices; and
channel conditions between the sensing device and each member of the set of candidate devices.

In yet another aspect of some but not necessarily all embodiments, for each member of the set of one or more responding devices, the response to the radar illumination assistance request indicates an availability status of said member of the set of one or more responding devices. In some such embodiments, determining the set of candidate devices comprises selecting one or more members of the set of one or more responding devices for inclusion in the set of candidate devices based at least in part on the availability status of each member of the set of one or more responding devices.

In still another aspect of some but not necessarily all embodiments, configuring the illuminating device to perform radar illumination comprises communicating illumination signal parameters to the illuminating device.

In another aspect of some but not necessarily all embodiments, an illumination trigger signal is transmitted to the illuminating device prior to sensing reflections of illumination signals transmitted by the illuminating device.

In yet another aspect of some but not necessarily all embodiments, another member of the set of one or more candidate devices is selected as another illuminating device, wherein the selecting is based at least in part on the determined relative positions. Said another illuminating device is configured to perform radar illumination, and reflections of illumination signals transmitted by said another illuminating device are sensed.

Some aspects of the inventive technology involve actions performed by an illuminating device in an arrangement that comprises a plurality of devices including the illuminating device. In some of these aspects, the illuminating device receives a radar illumination assistance request from the sensing device and transmits, to the sensing device, a response to the radar illumination assistance request. The illuminating device receives, from the sensing device, configuration parameters for performing radar illumination; and transmits a radar illumination signal according to the configuration parameters.

In another aspect of some but not necessarily all embodiments, the illuminating device receives an illumination trigger signal, wherein transmitting the radar illumination signal according to the configuration parameters is performed in response to the illumination trigger signal.

In yet another aspect of some but not necessarily all embodiments, the illumination trigger signal is received from the sensing device; and the illumination trigger event is receipt of the illumination trigger signal.

In still another aspect of some but not necessarily all embodiments, the illuminating device is associated with a telecommunications network node; and the illumination trigger event is detection of a telecommunications network event. In a non-limiting embodiment, the telecommunications network event can be a time instant within the telecommunications network.

In another aspect of some but not necessarily all embodiments, the response to the radar illumination assistance request includes a sequence indicative of an identity of the illuminating device.

In yet another aspect of some but not necessarily all embodiments, the response to the radar illumination assistance request comprises a sequence configured for use as a basis for estimating a range between the sensing device and the illuminating device.

In still another aspect of some but not necessarily all embodiments, the illuminating device receives a ranging signal request from the sensing device; and transmits a ranging signal response that is configured for use as a basis for estimating a range between the sensing device and the illuminating device.

In another aspect of some but not necessarily all embodiments, the ranging signal response indicates a mobility attribute of the illuminating device.

In yet another aspect of some but not necessarily all embodiments, transmitting the radar illumination signal according to the configuration parameters comprises transmitting the radar illumination signal at a lower strength in the direction of the sensing device than in other directions.

In still another aspect of some but not necessarily all embodiments, receiving the radar illumination assistance request from the sensing device comprises using a short-range transceiver to receive the radar illumination assistance request from the sensing device.

### BRIEF DESCRIPTION OF THE DRAWINGS

The objects and advantages of the invention will be understood by reading the following detailed description in conjunction with the drawings in which:

FIG. 1 illustrates a simple bi-static sensing scenario.

FIG. 2 illustrates a sensing device that is within communication range of three other devices and within sensing distance of an object.

FIG. 3 illustrates an example in which the three other devices have received the radar illumination request and respond.

FIG. 4 illustrates aspects of some inventive embodiments related to actions performed after a set of responding devices has sent illumination assistance response messages.

FIG. 5 illustrates aspects of inventive embodiments related to triggering a radar signal transmission for echo sensing.

FIG. 6 illustrates a substantially omni-directional illumination pattern from an illuminating device with weaker signal strength being directed towards the sensing device.

FIG. 7 is an exemplary sequencing diagram illustrating actions and communications that take place between devices configured in accordance with some inventive embodiments.

FIG. 8 is, in one respect, a flowchart of actions performed by a sensing device as part of a bi-static or multistatic radar operation in accordance with some but not necessarily all inventive embodiments.

FIG. 9 is, in one respect, a flowchart of actions performed by an illuminating device as part of a bi-static or multistatic radar operation in accordance with some but not necessarily all inventive embodiments.

FIG. 10 shows an exemplary controller that may be included in a sensing device or illuminating to cause any and/or all of the herein-described and illustrated actions associated with that device to be performed.

### DETAILED DESCRIPTION

The various features of the invention will now be described with reference to the figures, in which like parts are identified with the same reference characters.

The various aspects of the invention will now be described in greater detail in connection with a number of exemplary embodiments. To facilitate an understanding of the invention, many aspects of the invention are described in terms of sequences of actions to be performed by elements of a computer system or other hardware capable of executing programmed instructions. It will be recognized that in each of the embodiments, the various actions could be performed by specialized circuits (e.g., analog and/or discrete logic gates interconnected to perform a specialized function), by one or more processors programmed with a suitable set of instructions, or by a combination of both. The term “circuitry configured to” perform one or more described actions is used herein to refer to any such embodiment (i.e., one or more specialized circuits alone, one or more programmed processors, or any combination of these). Moreover, the invention can additionally be considered to be embodied entirely within any form of non-transitory computer readable carrier, such as solid-state memory, magnetic disk, or optical disk containing an appropriate set of computer instructions that would cause a processor to carry out the techniques described herein. Thus, the various aspects of the invention may be embodied in many different forms, and all such forms are contemplated to be within the scope of the invention. For each of the various aspects of the invention, any such form of embodiments as described above may be referred to herein as “logic configured to” perform a described action, or alternatively as “logic that” performs a described action.

Embodiments consistent with the invention address problems related to selection of cooperating units for bi- or multistatic radar measurement support. In an aspect of some inventive embodiments, technology is described herein that enables wireless devices (also referred to herein simply as “devices”) to cooperatively perform bistatic or multistatic radar measurements (e.g., ranging and/or Doppler estimation) requiring a minimum of resources, using two (or more) wireless devices without the need for full duplex capability, accurate synchronization between devices, or absolute position information. The devices should be within line of sight of each other or be located in close proximity of one another.

In one aspect of some inventive embodiments, a device planning to perform a radar measurement (herein denoted as a “sensing device”) transmits an illumination request in search of at least one other device that can perform radar illumination. Potential illuminating devices receive the illumination request and respond by transmitting one or more uniquely identifiable signals that allow their relative positions to be determined. The sensing device receives the response(s) and assesses them. Based on that assessment, the sensing device may select one or more illuminating devices from the set of candidates. The selected device(s) is/are then configured to perform radar illumination. The sensing device in cooperation with the illuminating device(s) can then perform radar measurements.

In another aspect of some but not necessarily all inventive embodiments, the potential illuminating devices respond with a first response that identifies them (e.g., via a transmitted identifying bit pattern, transmit frequency, CDMA coding, or other transmit characteristics) and optionally communicate their sequences. Each sequence is subsequently used for determining the range of the device relative to the sensing device. In some but not necessarily all embodiments, the sequence can also be used as a device identifier, thereby eliminating the need for separate signaling of this information. Communication of the sequence can take place over any short-range wireless technology (e.g., Bluetooth, WiFi, etc.). The sensing device then transmits ranging request messages to one or more of the potential illuminating devices that responded. The purpose of the ranging request is to find out a device's location (e.g., relative position). When a potential illuminating device receives a ranging request message (optionally with its sequence), it responds with a ranging signal based on the same sequence, transmitted over the cellular interface/HW to ensure sufficient bandwidth for the ranging operation. In an aspect of some but not necessarily all embodiments, the potential illuminating device waits a pre-determined and accurate amount of time after receiving the ranging request before it responds with its ranging signal. The first device can then determine the range from the time of arrival of the response relative to its transmission according to round trip time (RTT) principles. It can also determine the direction of the potential illuminating device by angle of arrival. Both the range and direction can be relative to the first device. Even if a ranging request related response does not include an optional sequence from the illumination request response, various different methods can instead be used to distinguish round trip time (RTT) ranging responses from potential multiple second devices like, for example, separation in the spatial domain, separation in the time domain (with pre-configured known delay responses) or the use of different pre-configured sequences.

In some but not necessarily all further inventive embodiments, the illumination request may also constitute a ranging transmission request and the response transmission itself may constitute a signal that can be used for ranging estimation for the relative position determination. These aspects can find application in any protocol or system standard, operating at any transmit frequency and system bandwidth. The performance of the ranging accuracy may differ dependent on the utilized frequency and bandwidth of the ranging signal and it may in some cases be beneficial to operate using cellular networks where available, allocated bandwidth may be relatively large. In some examples, multiple protocols or frequencies can be used in combination where one or more signals such as for example the illumination request and response may be transmitted using a different communication protocol or frequency than the ranging signals.

When a ranging response has been received from a potential illuminating device with favorable conditions, the sensing device selects that device as an illuminating device and sends out a request for illumination from that device. After receiving the request, the illuminating device transmits a radar signal. Preferably, but not essentially, the transmitted radar signal is beamformed to be weaker in the angle of arrival from where the request for ranging was received, in order to reduce the strength of the direct path when the sensing device receives it. Having received the radar signal from the direct path and the reflections, and having estimated the distance and direction to the illuminating device, a bi-static radar image can be calculated by the sensing device (or other device or network node if the information were communicated to that other device or network node), with the distances and directions to objects relative to itself.

This example assumes the case of bi-static operation. If multiple illuminating devices are selected, the operations with respect to the sensing device and each of the illuminating devices is as described above, and a multistatic radar image can be calculated.

A radar image with objects' locations relative to the sensing device is obtained, similar to what would result from a monostatic radar measurement by the sensing device, which is a preferrable representation for instance when navigating around obstacles. Of course, those of ordinary skill in the art would readily understand how to calculate an object's location in an absolute sense if the sensing device's absolute location coordinates and orientation are known or otherwise determined.

These and other aspects are now described in further detail.

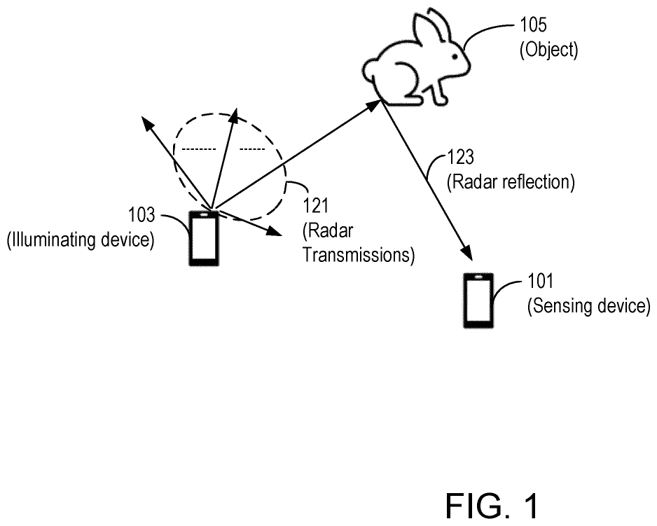

To illustrate various aspects of inventive embodiments, consider a simple bi-static sensing scenario as shown in FIG. 1. Two nearby devices (e.g., cellular telephones), namely a sensing device 101 and an illuminating device 103, are situated within line of sight of one another and are to cooperate to sense an object 105 (illustrated herein, without limitation, as a rabbit). The participating devices need not be phones. For example, and without limitation, either or both can be AR or VR glasses or headsets. Further, it is not essential that they be separated by any particular distance or carried by different users; the same user can be carrying both devices. Having the participating devices carried by the same user has an advantage in that it allows for continuity of availability and functionality. However, such is not essential to inventive embodiments because radar functionality can also be performed opportunistically when devices of other users are nearby.

As shown in the illustration, during radar functionality, the illuminating device 103 transmits one or more radar signals 121, some of which bounce off of the object 105 and are received by the sensing device 101 as one or more radar reflections 123.

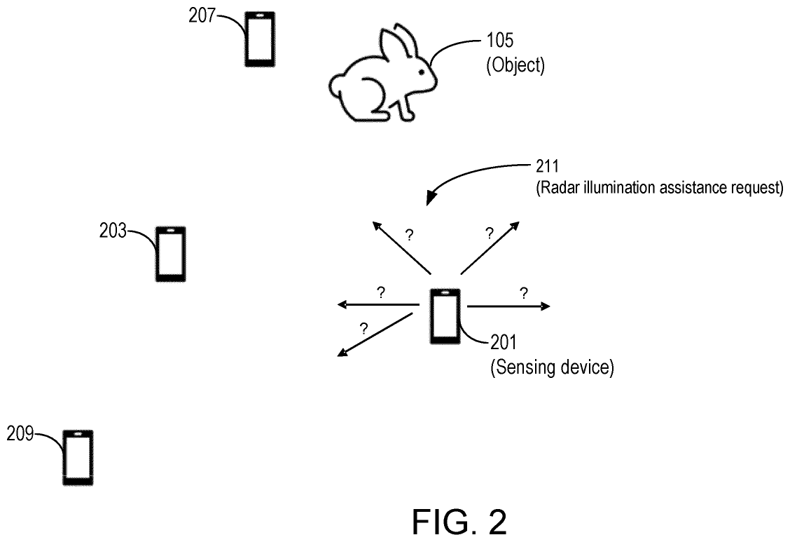

Aspects of inventive embodiments relate to how a device that wants to be a sensing device, can establish the cooperation of one or more other devices to act as illuminating devices, such as in the example of FIG. 1. To explain some of these aspects, reference is first made to FIGS. 2 through 6. Looking first at FIG. 2, this illustrates a sensing device 201 that is within communication range of three other devices 203, 207, 209 and within sensing distance of the object 105.

To start the process in which the sensing device 201 can establish the presence of one or more cooperating illuminating devices, the sensing device 201 checks for the presence of nearby devices. A Bluetooth (or other suitable technology such as IEEE 802.11 standard or other short range wireless technology) broadcast message is transmitted by device 201. The message is herein referred to as a radar illumination assistance request 211. When received by any of the devices 203, 207, 209, it is understood as a request for the device to identify itself. In some but not necessarily all embodiments, an identifying response will be sent only if the device is able to provide the illumination assistance. In other embodiments, a device may respond with an indication of a level of suitability for illumination assistance, or whether or not it is able to provide illumination assistance. Such level of suitability may, for example, indicate one or more parameters related to the device mobility characteristics, transmitter characteristics or capabilities such as available bandwidth, transmit power, antenna configuration, and the like.

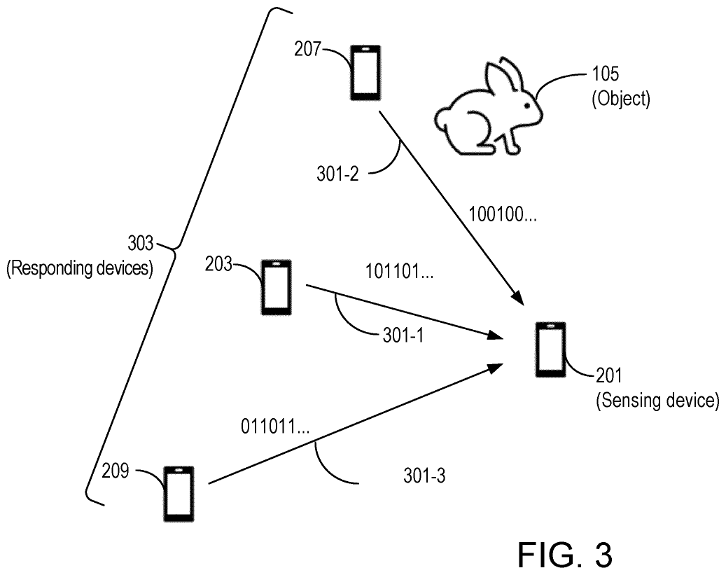

Referring now to FIG. 3, this illustrates an example in which the three devices 203, 207, 209 have received the radar illumination assistance request 211 and respond. Each response 301-1, 301-2, 301-3 to the radar illumination request indicates the presence and ability of each respective responding device 203, 207, 209 to assist, and the response may in some examples also contain a sequence of the device which is used when listening to and responding to ranging and illumination requests. In FIG. 3, the sequences 1011 . . . , 0110 . . . , and 1001 . . . are shown, respectively, to illustrate this aspect in a non-limiting way.

In order to allow the illuminating device 201 to select the most suitable devices(s) from among the set 303 of responding devices, each response message 301-1, 301-2, 301-3 is indicative of the responding device's availability. In other words, a device that determines that it is available for supporting the sensing will respond to the assistance request. Further, the response may, in some but not necessarily all embodiments, be indicative of a suitability level. One aspect of suitability can be, for example, the extent of a device's mobility (i.e., the more a device is moving relative to the sensing device, the less suitable it may be, compared with a relatively stationary device). The mobility level may be determined as an average over time.

In an aspect of some but not necessarily all embodiments, a device may be configured to select from a number of possible sequences, with selection being based on the suitability level. A set of pre-defined sequence types indicating different suitability levels may be used, so that the sensing device 201 can determine the illumination suitability level of a given responding device based on the sequence type. A sequence type may be a sequence index or a variant of sequence construction.

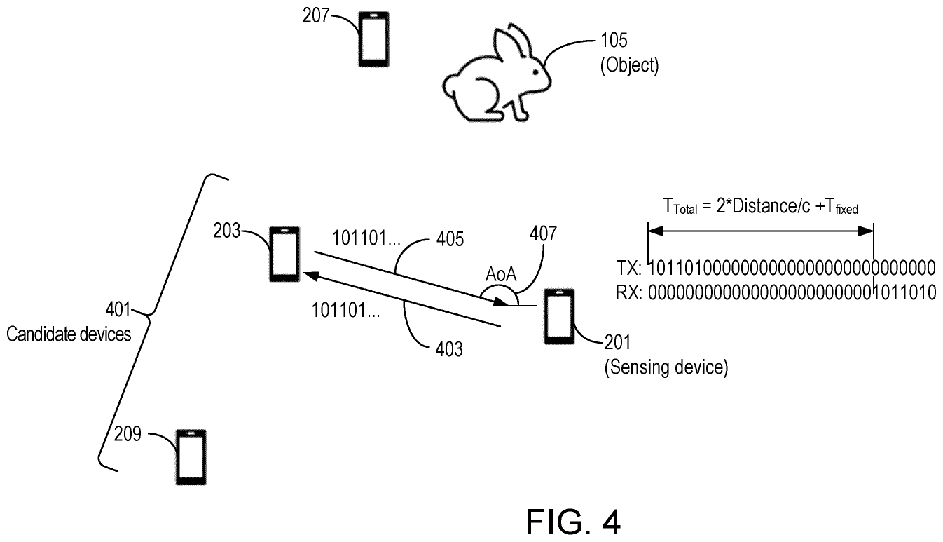

FIG. 4 illustrates aspects of some inventive embodiments related to actions performed after a set 303 of responding devices has sent response messages 301-1, 301-2, 301-3. In response to receipt of those messages, the sensing device 201 then determines if one or more of the responding devices are suitable based on their responses. These suitable responding devices are herein referred to as candidate devices 401. For the sake of example, and without limitation, in FIG. 4 the device 203 and device 209 are considered candidate devices 401.

The sensing device 201 transmits ranging request messages in different beam directions to find the different suitable devices 203, 209. If the optional feature in which a sequence identifying the devices are indicated in the response messages 301-1, 301-2, 301-3, the sensing device 201 may use the communicated sequences in its ranging request message, such as is illustrated in the ranging request message 403. When a candidate device 203 receives the ranging request message 403 (optionally with its radar sequence), it transmits the sequence back in a ranging message response 405, in the same direction from which it was received. In some but not necessarily all embodiments, this response transmission is made after a pre-determined and precise time interval, starting from when the candidate device 203 received the ranging message 403.

The sensing device 201 searches for a ranging message response 405. The search pattern will depend on the capabilities of the sensing device 201 and what beam patterns are supported. The search may start with those devices that had the highest signal strength when responding to the radar illumination assistance request message 211, and finish without needing to range the more distant devices.

The distance to a device can be determined by measuring the time between transmitting the ranging message 403 and receiving the ranging message response 405, minus the fixed waiting time (in embodiments utilizing a fixed waiting time). The purpose of the fixed waiting time is to allow both devices time to switch between transmit and receive operations (i.e., to avoid the need for supporting full duplex operation or very fast switches). Known techniques for round-trip time measurements that account for the intermediate delays may be applied for the distance estimation.

The direction from the sensing device 201 towards the other device is determined by angle of arrival estimation 407. The estimated angle of arrival is relative to the sensing device position and orientation. The signal strengths of these short-range line of sight connections is high enough that the phase of the signals at individual antenna elements can be directly measured with beam shape matched filtering in high SNR scenarios, resulting in accurate angle of arrival measurements, in case the sensing device 201 supports full digital beamforming. Alternatively (e.g., if the sensing device 201 does not support full digital beamforming), the direction can be found using beam and null sweeping/scanning applied to the ranging message response 405, which is more time consuming. For improved accuracy, instead of detecting maximum received energy during beam lobe sweeping, a null formed by two or more antenna elements may be swept and the minimum of the null/notch may be used as the AoA estimate 407.

It is beneficial for the accuracy of the radar measurement that the cooperating devices have a line-of-sight connection. When that is present, the relative positioning using angle and time of flight between the illuminating device 201 and the illuminating device 203 works well, and the bi-static radar measurement will have an accurate reference path to which echo signal timing can be compared. In most cases, the operation should only be initiated if a line-of-sight path has been found. One exception is the case in which the distance between the illuminating and sensing devices is very short, in which case the errors will be limited. The line-of-sight property can be determined based on the impulse response obtained by the sensing device 201 when correlating for the sequence of the candidate device 203 when receiving the ranging message response 405. The first correlation peak, corresponding to line-of-sight propagation, should then be stronger than the ones from signals arriving later. If that is not the case, then there is not a line-of-sight relationship between the two devices. In an aspect of some but not necessarily all embodiments, measures for line-of-sight properties can be defined, and a candidate device is used only if the measured line-of-sight property is above a certain threshold.

The threshold can be made distance dependent, so that the requirement is relaxed for close distances.

In some but not necessarily all embodiments, the ranging request message 403 may be an express signaling (such as is illustrated in FIG. 4). But in some but not necessarily all alternative embodiments, a ranging request message is implicit, for example, implied as part of the broadcasted radar illumination assistance request 211. A consequence of the strategy in this alternative is that the ranging signaling will be expected to be performed by all devices responding to the broadcasted radar illumination assistance request 211.

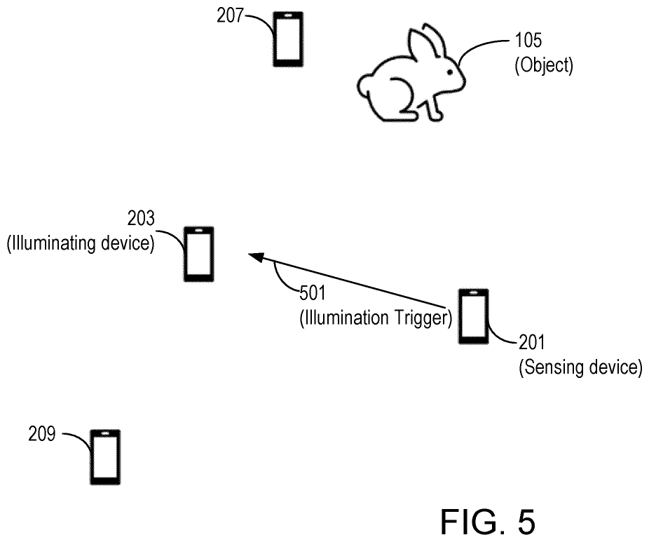

In yet other non-limiting alternatives, a ranging request message can be implied to be present in part of an illumination trigger signal (described below with reference to FIG. 5).

After the sensing device 201 receives responses 405 from the set 401 of candidate devices and derives information about each of these (e.g., whether there is a line-of-sight relationship between a given candidate device and the sensing device 201, the relative location and range of the given candidate device, etc.), the sensing device 201 selects which one or more of the set 401 of candidate devices will participate as an illuminating device. Selection is based on such factors as, without limitation, geometries (relative distances and angles) between sensing device 201, candidate device 203, 207, 209, and the locations of the sensing areas of interest.

Referring now to FIG. 5, this illustrates aspects of inventive embodiments related to radar signal transmission and echo sensing. To perform the actual radar measurement, the sensing device 201 transmits an illumination trigger request 501 to the illuminating device 203. The request could be sent via Bluetooth or other short range communication standard. In some but not necessarily all alternative embodiments, the illumination trigger request 501 can be sent as a radar transmission with a new sequence derived from the first using a known mapping, or as a new sequence that is communicated between the devices.

The illuminating device 203 will be aware of the angle of arrival of the illumination trigger signal 501 either from the radar message, or from the previous ranging messages. When the illumination trigger signal 501 is received, the illuminating device responds by illuminating the surroundings. In an aspect of some but not necessarily all embodiments, in doing the illuminating, less energy is directed towards the sensing device 201 than in other directions. This has the beneficial effect of reducing the strength of the signal received by the sensing device 201 over the direct path, so that less dynamic range is needed to receive both the direct reference path and the weak echoes in the sensing device 201.

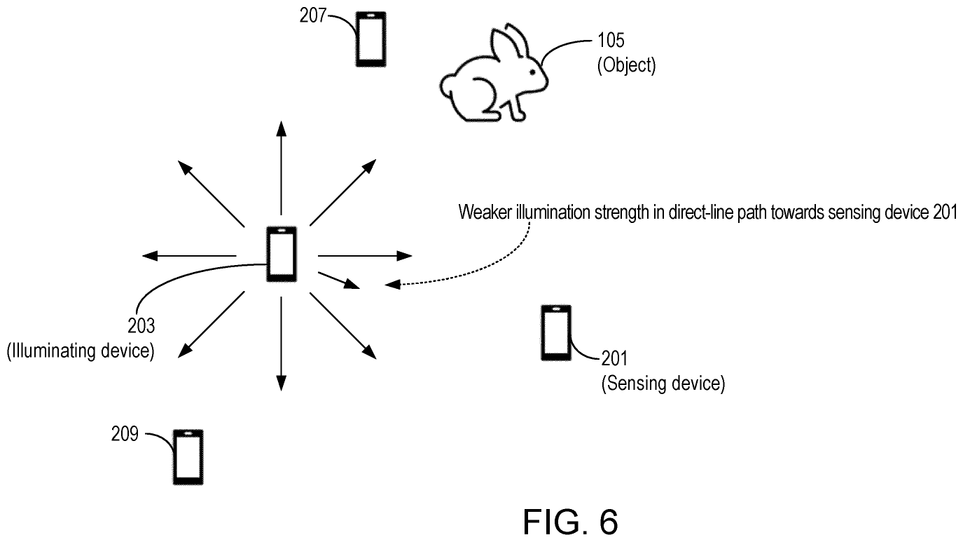

The illumination can occur in different patterns. FIG. 6 illustrates one of these in which a substantially omni-directional illumination is transmitted from the illuminating device 203 but with a weaker signal strength being directed towards the first device. With this illumination pattern, there is no need for coordination between the illuminating and sensing devices 203, 201 regarding illumination directions.

In some alternative embodiments, illumination instructions are included in the illumination trigger signal 501, directing the illuminating device 203 to illuminate in particular directions relative to its angle of arrival.

In yet other non-limiting embodiments, fixed sequences of patterns for illumination are agreed upon in advance between devices, in which case it is only necessary for the sensing device 201 to communicate which of these should be used. In the special case in which there is only one fixed sequence, there is no need to communicate an identification of the illumination pattern.

Mobility or other parameters may change during the radar operation, and this can detrimentally affect the quality of radar sensing/measurement because once-suitable illuminating devices can become unsuitable. The sensing device 201 may maintain a level of device suitability over time by, at some intervals, transmitting new broadcast radar illumination assistance request messages 211 to re-initiate the device selection procedure. In another aspect that can be used as an alternative or in combination with, at times, re-initiating the device selection procedure, the illuminating device 201 may transmit an indication when it determines that its own factors affecting its suitability are changing in a way that will detrimentally impact its suitability for continued participation in the radar functionality. One way out of many that such an indication can be communicated is by changing the illuminating device's sequence to a variant of the earlier sequence so that it still identifies the illuminating device 203 but also indicates to the sensing device 201 that the illumination conditions are changed.

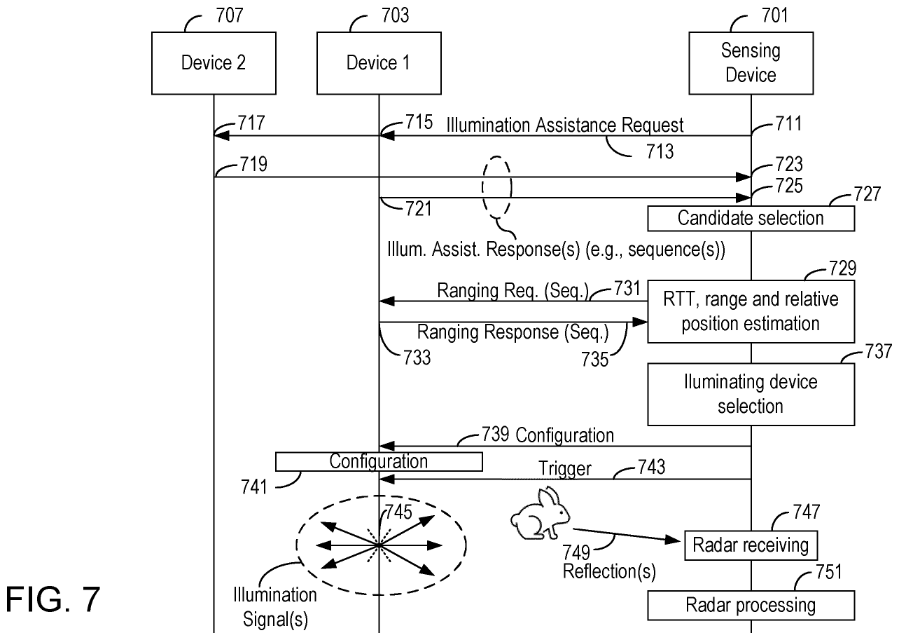

Further aspects of inventive embodiments will now be described with reference to FIG. 7 which is an exemplary sequencing diagram illustrating actions and communications that take place between devices configured in accordance with some inventive embodiments. In this non-limiting example, a sensing device 701 is near a first device 703 and a second device 707. The sensing device 701 broadcasts (step 711) an illumination assistance request 713 into its surroundings, it is received by the first device 703 (step 715) and the second device 707 (step 717). Each device responds (steps 719, 721) with an illumination assistance response, and these are received (steps 723, 725) by the sensing device 701.

The responses can provide information for assisting with selection of one or more devices for use as illuminating devices. For example, signal properties of the responses can be useful (e.g., received signal strength and/or delay spread can be assessed and used to determine which devices are very likely to be within line-of-sight of the sensing device 701). In some alternatives, other helpful device specific information, such as device mobility information, can be included in the response. Based on these responses, and in accordance with principles described above, the sensing device 701 in this example selects 727 the first device 703 as the candidate device. The sensing device then determines the range of the (candidate) first device 703 (step 729) by transmitting a ranging request message (including the first device's ranging sequence) 731 to the first device 703 and then receiving the ranging response message 735 that was transmitted (step 733) by the first device 703 in response to the ranging request.

After determining the first device's range, direction, and other suitability factors, the sensing device 701 selects (step 737) the (candidate) first device 703 to participate as an illuminating device. The sensing device 701 then sends configuration parameters to the (illuminating) first device 703 (step 739). As discussed earlier, such parameters may include, without limitation, such things as illumination pattern to be used, signal strength, and the like. In response, the (illuminating) first device 703 configures itself accordingly (step 741).

After allowing sufficient time for the configuration, and when the sensing device 701 is ready to perform scanning, it sends an illumination trigger signal 743 to the (illuminating) first device 703. The illuminating first device 703 responds by illuminating its surroundings with radar signals in accordance with the agreed illumination pattern (step 745). Meanwhile, the sensing device activates its receiver and begins scanning (step 747) for radar reflections 749. Received radar reflections are then processed to produce a radar image based on the estimated relative position of the (illuminating) first device 703 (step 751).

In some but not necessarily all alternative embodiments, the sending of an illumination trigger signal 743 to the (illuminating) first device 703 is omitted. Instead, the sending of the configuration parameters to the (illuminating) first device 703 (step 739) implicitly (or in some embodiments, explicitly) indicates when illumination is to be started. In such embodiments, the device's receipt of the configuration parameters is the illumination triggering event.

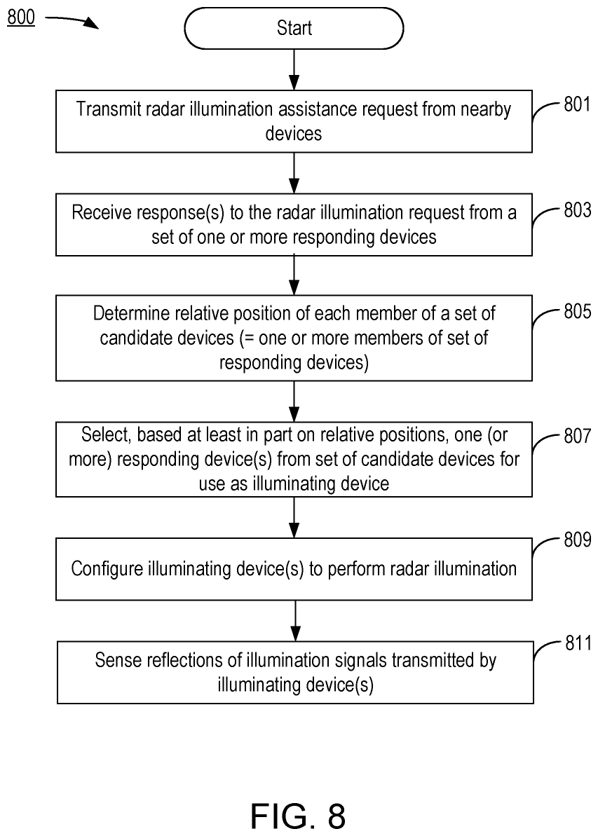

Still further aspects of some but not necessarily all inventive embodiments will now be described with reference to FIG. 8, which in one respect is a flowchart of actions performed by a sensing device as part of a bi-static or multistatic radar operation in accordance with some but not necessarily all inventive embodiments. In other respects, the blocks depicted in FIG. 8 can also be considered to represent means 800 (e.g., hardwired or programmable circuitry or other processing means) for carrying out the described actions.

As shown beginning in FIG. 8, the process includes the sensing device transmitting a radar illumination assistance request from the sensing device (step 801). The sensing device then receives a response to the radar illumination assistance request from a set of one or more responding devices (step 803). The sensing device then determines a relative position of each member of a set of candidate devices, wherein the set of candidate devices consists of one or more members of the set of one or more responding devices (step 805).

The sensing device then selects one or more of the responding devices from the set of candidate devices for use as an illuminating device, wherein the selecting is based at least in part on the determined relative positions (step 807).

The selected illuminating device(s) is/are then configured to perform radar illumination (step 809).

When the illuminating device(s) will be transmitting radar illumination, the sensing device senses reflections of illumination signals transmitted by the illuminating device(s) (step 811).

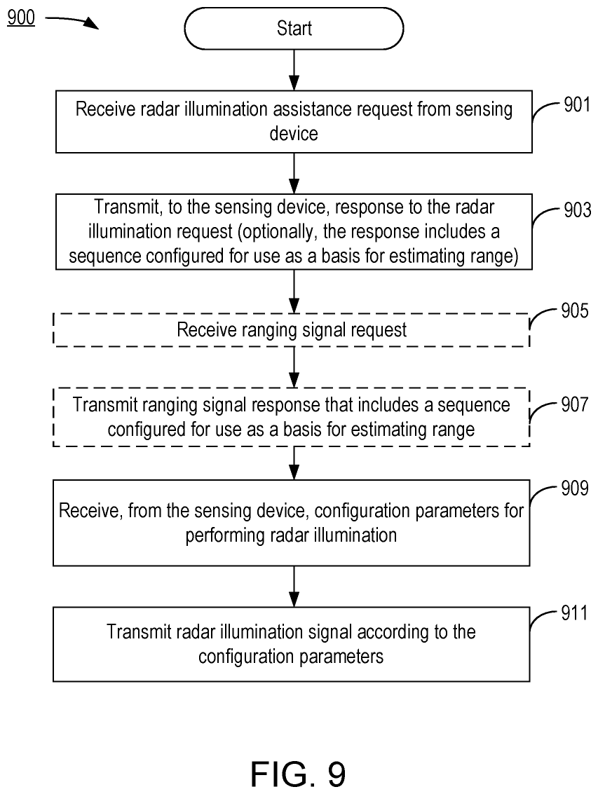

Still further aspects of some but not necessarily all inventive embodiments will now be described with reference to FIG. 9, which in one respect is a flowchart of actions performed by an illuminating device as part of a bi-static or multistatic radar operation. In other respects, the blocks depicted in FIG. 9 can also be considered to represent means 900 (e.g., hardwired or programmable circuitry or other processing means) for carrying out the described actions.

As shown beginning in FIG. 9, the process includes the illuminating device receiving a radar illumination assistance request from the sensing device (step 901). In response, the illuminating device transmits, to the sensing device, a response to the radar illumination assistance request (step 903). In some but not necessarily all embodiments, the response includes a sequence configured for use as a basis for estimating a range between the sensing device and the illuminating device.

In some but not necessarily all alternative embodiments, the illuminating device receives a ranging signal request from the sensing device (step 905) and transmits a ranging signal response that is configured for use as a basis for estimating a range between the sensing device and the illuminating device (step 907).

The illuminating device then receives, from the sensing device, configuration parameters for performing radar illumination (step 909). The illuminating device then transmits a radar illumination signal according to the configuration parameters (step 911). In some but not necessarily all embodiments, transmission of the radar illumination signal can be triggered implicitly by receipt of the configuration parameters. In some but not necessarily all alternative embodiments, the transmission of the radar illumination signal is triggered by receipt of a trigger signal (e.g., as illustrated by step 743 in FIG. 7).

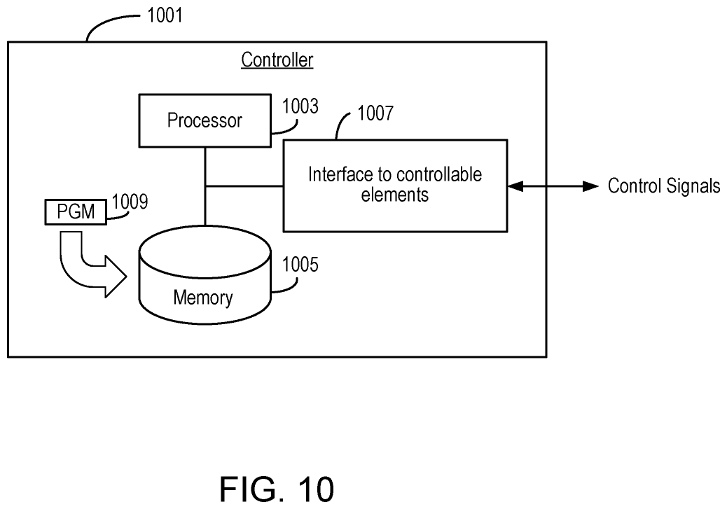

Further aspects of embodiments consistent with the invention will now be described with reference to FIG. 10, which shows an exemplary controller 1001 that may be included in a sensing device or in an illuminating device to cause any and/or all of the herein-described and illustrated actions associated with that device to be performed. In particular, the controller 1001 includes circuitry configured to carry out any one or any combination of the various functions described herein. Such circuitry could, for example, be entirely hard-wired circuitry (e.g., one or more Application Specific Integrated Circuits—“ASICs”). Depicted in the exemplary embodiment of FIG. 10, however, is programmable circuitry, comprising a processor 1003 coupled to one or more memory devices 1005 (e.g., Random Access Memory, Magnetic Disc Drives, Optical Disk Drives, Read Only Memory, etc.) and to an interface 1007 that enables bidirectional communication with other elements of a device as described above. A complete list of possible other elements is beyond the scope of this description.

The memory device(s) 1005 store program means 1009 (e.g., a set of processor instructions) configured to cause the processor 1003 to control other device elements so as to carry out any of the aspects described herein. The memory device(s) 1005 may also store data (not shown) representing various constant and variable parameters as may be needed by the processor 1003 and/or as may be generated when carrying out its functions such as those specified by the program means 1009.

Embodiments consistent with aspects of the invention provide a number of advantages over conventional technology. Such advantages include, without limitation:
The absence of any need for full duplex functionality in any device
The absence of any need for accurate absolute positioning of any device
A capability of using the same transmitted signal for both object illumination and use as an over the air synchronization reference (using line-of-sight direct path transmissions). This eliminates any need for synchronization between devices.
The resultant radar imaging results in objects' positions being obtained relative to the first device, just as if monostatic sensing had been performed
Simplicity of functionality for device cooperation, angle of arrival, and fixed time delay
Good performance when there is a nearby device
Simplicity with respect to selection of suitable radar illuminating device(s).

The invention has been described with reference to particular embodiments. However, it will be readily apparent to those skilled in the art that it is possible to embody the invention in specific forms other than those of the embodiment described above. Thus, the described embodiments are merely illustrative and should not be considered restrictive in any way. The scope of the invention is further illustrated by the appended claims, rather than only by the preceding description, and all variations and equivalents which fall within the range of the claims are intended to be embraced therein.

1-58. (canceled)

59. A method of performing a multi-device radar sensing, wherein the method is performed by a sensing device and comprises:
transmitting a radar illumination assistance request from the sensing device;
receiving a response to the radar illumination assistance request from a set of one or more responding devices;
determining a relative position of each member of a set of candidate devices, wherein the set of candidate devices consists of one or more members of the set of one or more responding devices;
selecting one of the responding devices from the set of candidate devices for use as an illuminating device, wherein the selecting is based at least in part on the determined relative positions;
configuring the illuminating device to perform radar illumination; and
sensing reflections of illumination signals transmitted by the illuminating device, wherein
determining the relative position of each member of the set of candidate devices comprises receiving, from each member of the set of candidate devices, at least one ranging transmission that is configured for use as a basis for estimating a range between the sensing device and the member of the set of candidate devices.

60. The method of claim 59, wherein determining the relative position of each member of the set of candidate devices comprises, for each member of the set of candidate devices, determining an angle of arrival of the at least one ranging transmission received from the member of the set of candidate devices.

61. The method of claim 59, wherein determining the relative position of each member of the set of candidate devices comprises, for each member of the set of candidate devices, estimating a distance between the sensing device and the member of the set of candidate devices.

62. The method of claim 61, wherein estimating the distance between the sensing device and the member of the set of candidate devices comprises determining a round trip time that comprises a combination of:
a travel time of a first signal from the sensing device to the member of the set of candidate devices;
a known delay time between receipt of the first signal by the member of the set of candidate devices and transmission of a second signal by the member of the set of candidate devices; and
a travel time of the second signal from the member of the set of candidate devices to the sensing device.

63. The method of claim 60, wherein determining the angle of arrival of the at least one ranging transmission received from the member of the set of candidate devices comprises using an antenna array of the sensing device to perform null-scanning over a geographical region.

64. A method of performing a multi-device radar sensing in an arrangement that comprises a plurality of devices including an illuminating device and a sensing device, wherein the method is performed by the illuminating device and comprises:
receiving a radar illumination assistance request from the sensing device;
transmitting, to the sensing device, a response to the radar illumination assistance request;
receiving, from the sensing device, configuration parameters for performing radar illumination; and
transmitting a radar illumination signal according to the configuration parameters.

65. The method of claim 64, wherein the response to the radar illumination assistance request comprises a sequence configured for use as a basis for estimating a range between the sensing device and the illuminating device.

66. The method of claim 64, comprising:
receiving a ranging signal request from the sensing device; and
transmitting a ranging signal response that is configured for use as a basis for estimating a range between the sensing device and the illuminating device.

67. The method of claim 64, wherein transmitting the radar illumination signal according to the configuration parameters comprises transmitting the radar illumination signal at a lower strength in the direction of the sensing device than in other directions.

68. An apparatus for performing a multi-device radar sensing among a plurality of devices including an illuminating device and a sensing device, wherein the apparatus comprises circuitry configured to cause the sensing device to:
transmit a radar illumination assistance request from the sensing device;
receive a response to the radar illumination assistance request from a set of one or more responding devices;
determine a relative position of each member of a set of candidate devices, wherein the set of candidate devices consists of one or more members of the set of one or more responding devices;
select one of the responding devices from the set of candidate devices for use as an illuminating device, wherein the selecting is based at least in part on the determined relative positions;
configure the illuminating device to perform radar illumination; and
sense reflections of illumination signals transmitted by the illuminating device;
wherein, to determine the relative position of each member of the set of candidate devices, the circuitry is configured to cause the sensing device to determine, for each member of the set of candidate devices, an angle of arrival of the at least one ranging transmission received from the member of the set of candidate devices.

69. The apparatus of claim 68, wherein the circuitry is configured to cause the sensing device to estimate, for each member of the set of candidate devices, a distance between the sensing device and the member of the set of candidate devices.

70. The apparatus of claim 68, wherein the circuitry is configured to cause the sensing device to perform null-scanning over a geographical region, using an antenna array of the sensing device.

71. An apparatus for performing a multi-device radar sensing among a plurality of devices including an illuminating device and a sensing device, wherein the apparatus comprises circuitry configured to cause the illuminating device to:
receive a radar illumination assistance request from the sensing device;
transmit, to the sensing device, a response to the radar illumination assistance request;
receive, from the sensing device, configuration parameters for performing radar illumination; and
transmit a radar illumination signal according to the configuration parameters;
wherein the response to the radar illumination assistance request comprises a sequence configured for use as a basis for estimating a range between the sensing device and the illuminating device.

72. The apparatus of claim 71, wherein the circuitry is configured to cause the illuminating device to transmit the radar illumination signal at a lower strength in the direction of the sensing device than in other directions.

73. The apparatus of claim 71, wherein the circuitry is configured to cause the illuminating device to use a short-range transceiver to receive the radar illumination assistance request from the sensing device.
